(19) United States
(12) Patent Application Publication
(10) Pub. No.: US 2012/0085930 A1
(43) Pub. Date: Apr. 12, 2012

(54) DETECTION METHOD

(75) Inventors: Paul Bonnett, Basel (CH); Nelson Johnson, Greensboro, NC (US)

(73) Assignee: SYNGENTA CROP PROTECTION LLC, Greensboro, NC (US)

(21) Appl. No.: 13/203,058

(22) PCT Filed: Feb. 26, 2010
(86) PCT No.: PCT/US10/25472

§ 371 Date: Dec. 12, 2011

Related U.S. Application Data
(60) Provisional application No. 61/156,185, filed on Feb. 27, 2009.

(51) Int. Cl. G01N 21/64

(52) U.S. Cl. 250/459.1; 250/458.1

(57) ABSTRACT

The present invention relates to a method for detecting the presence of a fungicide on a seed. In particular, the method according to the invention may be used to ensure that sufficient quantities of the fungicide or insecticide are present on the seed. In a particular embodiment the fungicide detected is thiabendazole.

The present invention relates to a method for detecting the presence of pesticides on a crop seed. In particular, the method according to the invention may be used to ensure that sufficient quantities of the pesticide are present on a crop seed.

A liquid chromatographic based method for determining the presence of thiabendazole (TBZ) residues on citrus fruits is known from J-AOAC-Int. 1996 March-April; 79(2): 579-82. This method uses fluorescence detection, however, it requires that the sample be subjected to a lengthy and complicated liquid chromatography technique prior to the fluorescence analysis. The present invention provides a series of advantages over the prior art including the ability to rapidly analyse seed samples during, or following, the seed treating process to determine the presence of pesticides and the quantification thereof without the use of liquid chromatography. The invention therefore provides significant improvements over the prior art.

According to the present invention there is provided a method for detecting the presence of a fungicide in a liquid sample extracted from a seed during, or following, the seed treating process comprising: (a) providing an aqueous and/or an organic/aqueous sample to be tested; (b) subjecting said sample to electromagnetic radiation of a wavelength sufficient to excite fluorophores comprised by the fungicide; (c) detecting fluorescence of said fluorophore in said sample. In a particular embodiment the sample to be tested is an aqueous sample. In a further embodiment the sample to be tested is an organic/aqueous sample. In a still further embodiment the sample to be tested is an organic sample.

The term “seed” as used herein is inclusive of both true seeds and other types of plant propagation material. A true seed, for example, generally includes at least an embryo and seed coat such as those found with seeds of cereals and legumes. Common cereals include, but are not limited to, maize, rice wheat, barley, and sorghum. Common legumes include, but are not limited to, beans, peas, and peanuts. Plant propagation material includes all materials which will propagate into a plant. A common example of known propagation materials are cuttings, for example, a potato seed.

Examples of organic solvents applicable to the present invention include acetonitrile, alcohols such as methanol, ethanol, propanol, ketones such as acetone, hydrocarbons such as hexane and aromatics such as toluene.

The present invention still further provides a method as described above wherein detection of said fluorescence allows the quantification of the fungicide in said sample.

The present invention still further provides a method as described above wherein the wavelength which excites the flouorophores comprised by said fungicide is about 305 nm. In a particular embodiment said wavelength is 305 nm.

The present invention still further provides a method as described above wherein the wavelength of the fluorescence signal emitted by the excited fluorophore is about 360nm. In a further embodiment said wavelength is 360 nm.

In a particular embodiment of said method the fungicide is Thiabendazole. Thiabendazole (TBZ) is listed as entry 790 in The Pesticide Manual, Thirteenth Edition, published by The British Crop Protection Council, 2003. TBZ is mainly known as a fungicide for use on crops. We have surprisingly found that the fluorescence characteristics of TBZ can be used to calculate and quantify the presence and amount of TBZ containing fungicidal formulations during, and following the treatment of seeds.

The present invention still further provides a method as described above wherein the fluorescence is detected via a fluorescence spectrometer.

The present invention still further provides a method as described above wherein said seeds are analysed during the seed treating process to ensure that the seed is coated sufficient quantities of the fungicide. In a particular embodiment the seeds are analysed following the seed treatment process to confirm that the seeds contain sufficient quantities of the fungicide. In a still further embodiment the results of the analysis are used to control the amount of pesticides that are added to the seeds during the treatment process.

The present invention further provides a method for determining the amount of fungicide present on a crop seed comprising: (a) applying a desired level of fungicide to the seeds during the seed treatment process; and (b) extracting the applied fungicide from a seed; (c) analysing the level of fungicide in the extracted fungicide; and (d) deducing the level of fungicide applied to the seed based on the level of fungicide present in the extracted fungicide.

The present invention further provides a method for determining the amount of pesticides present on a crop seed comprising: (a) adding a desired level of one or more fungicides to the seeds during the seed treatment process; (b) extracting at least one applied fungicide from a seed; (c) analysing the level of the at least one fungicide in the extracted fungicide; (d) deducing the level of the at least one fungicide applied to the seed based on the level of the at least one fungicide present in the extracted fungicide; and (e) correlating the level of all fungicides applied to the seed based on either the deduced level of the at least one fungicide applied to the seed or the level of the at least one fungicide present in the extracted fungicide.

The present invention further provides a method for determining the amount of pesticides present on a crop seed comprising: (a) adding a desired level of thiabendazole and one or more fungicides or insecticides to the seeds during the seed treatment process; (b) extracting the thiabendazole from a seed; (c) analysing the level of thiabendazole in the extracted fungicide; (d) deducing the level of thiabendazole applied to the seed based on the level of thiabendazole present in the extracted thiabendazole; and (e) correlating the level of fungicides and/or insecticides applied to the seed based on either the deduced level of thiabendazole applied to the seed or the level of thiabendazole present in the extracted thiabendazole.

The present invention further provides an apparatus comprises a detecting mechanism which detects the presence of a fungicide in an aqueous sample generated during, or following, the seed treatment process, the apparatus comprising: (a) a means for providing an aqueous sample to be tested; (b) a means for subjecting said sample to electromagnetic radiation of a wavelength sufficient to excite fluorophores comprised by said fungicide; (c) a means for detecting fluorescence of said fluorophore in said sample.

The present invention still further provides an apparatus as described above wherein said apparatus further comprises a means for performing the method of determining the amount of fungicide present in the seed as described above.

The present invention still further provides the use of a fluorescence detector in the detection of a fungicide in an aqueous sample which is generated during, or following, a seed treatment process. In a particular embodiment the detector is a quantitative one. In a further embodiment the fungicide is thiabendazole.

In a still further embodiment of said method the wavelength which excites the flouorophores comprised by said fungicide is about 305 nm. In a still further embodiment of said method, the wavelength of the fluorescence signal emitted by the excited fluorophore is about 360 nm. In a still further embodiment of said method said fungicide is thiabendazole. In a still further embodiment of said method the fluorescence is detected via a fluorescence spectrometer.

The present invention further provides for a portable kit for performing the methods of present technology. The kit may include any of the following items: one or more containers, an extraction fluid, a sonicator (e.g. sonic bath), a dilution solution, a buffer solution, a pipette, a filter, a fluorescence spectrometer, a power source, a light source, and/or a computer.

Preferred extraction fluids of the present technology are generally organic solvents include, for example, acetonitrile, alcohols such as methanol, ethanol, propanol, ketones such as acetone, hydrocarbons such as hexane and aromatics such as toluene. A particularly preferred extraction solutions of the present technology is methanol.

A sonicator is device which produces sound energy, generally ultrasonic, to agitate particles and to facilitate extraction from the seed. A sonicator is also known as an ultrasonic bath or ultrasonic probe. One example of a commercially available sonicator is the Branson Model B1510-MT.

Fluorescence spectrometers and light sources are known in the art. Commercially available spectrometers and light sources include those manufactured by Ocean Optics of Dunedin, Florida, such as the Ocean Optics PX-2 light source and a USB 4000 fluorescence detector.

The present invention will now be further defined with reference to the following non-limiting examples:

Seed Treatment Analysis

### EXAMPLE 1

Treat 700 grams of Corn seed with a commercial seed treatment formulation containing 26.55 wt% Thiabendazole with the following recipe:

Commercial formulation: 2.95 grams

Beckerwood Color Coat Red Liquid: 0.16 grams

Florite 1085 polymer: 0.45 grams

Water: 3.12 grams

Allow seeds to dry.

Analysis of Treated Seeds by Fluorescence Spectroscopy:

A known weight of seeds (˜4 grams) treated with either thiabendazole (TBZ) alone or with thiabendazole mixed with other fungicides at about the 0.1% (1000 ppm) level is added to a glass vessel. Ten (10) ml of 0.05M phosphate buffer (pH 4.5) is added and the mixture shaken for about 15 minutes. Ten (10) ml of methanol is added to the mixture and the mixture shaken for another 15 minutes. An aliquot of the mixture is filtered through a 0.45 um filter. The filtered extract is diluted with 0.05M phosphate buffer (pH 4.5) to yield a thiabendazole concentration of about 1 ppm. The diluted extract containing about 1 ppm TBZ is transferred to a cuvette and the fluorescence spectra of TBZ is generated. The fluorescence intensity of TBZ at about 360 nm is recorded. The concentration of TBZ in the solution is determined from a standard curve of TBZ concentration vs TBZ fluorescence intensity at 360 nm.

### EXAMPLE 2

Treat 700 grams of Corn seed with a commercial seed treatment formulation containing 26.55 wt % Thiabendazole with the following recipe:

Commercial formulation: 0.82 grams

Beckerwood Color Coat Red Liquid: 0.16 grams

Florite 1085 polymer: 0.45 grams

Water: 3.12 grams

Allow seeds to dry.

Identical analysis method described in Example 1 is used.

Results

The seed extracts were analyzed by Fluorescence Spectroscopy and by Liquid Chromatography (HPLC).

| TBZ Level | Fluorescence | |
|---|---|---|
| (theoretical) | Spectroscopy (360 nm) | HPLC (UV at 305 nm) |
| 0.04% | 0.039% | 0.038% |
| 0.1% | 0.106% | 0.099% |

The ratios of the other fungicidal components in the formulation are retained at a fixed ratio and therefore the concentration of thiabendazole can be used to predict the level of other pesticides and formularies on the seed.

1. A method for detecting the presence of a fungicide in a liquid sample extracted from a sample generated during, or following, the pesticidal treatment of a seed comprising:
(a) providing an aqueous and/or an organic/aqueous sample to be tested, wherein the sample contains a fungicide extracted from a seed;
(b) subjecting the sample to electromagnetic radiation of a wavelength sufficient to excite fluorophores comprised by the fungicide;
(c) detecting fluorescence of the fluorophore in the sample.

2. The method according to claim 1, further comprising quantifying the fungicide in the sample based on the detection of fluorescence.

3. The method of claim 1, where the fungicide is thiabendazole.

4. The method of claim 3 wherein the wavelength which excites the flouorophores comprised by said fungicide is about 305 nm.

5. A method according to claim 4 wherein the wavelength of the fluorescence signal emitted by the excited fluorophore is about 360 nm.

6. A method according to claim 5 wherein said fungicide is thiabendazole.

7. A method according to claim 1 wherein the fluorescence is detected via a fluorescence spectrometer.

8. A method for determining the amount of fungicide present on a seed, the method comprising:
(a) applying a desired level of a fungicide to a seed during a seed treatment process; and
(b) extracting the applied fungicide from a seed;
(c) analysing the level of fungicide in the extracted fungicide; and
(d) deducing the level of fungicide applied to the seed based on the level of fungicide present in the extracted fungicide.

9. A method for determining the amount of fungicides present on a seed, the method comprising:
(a) adding a desired level of one or more fungicides to the seeds during the seed treatment process;
(b) extracting at least one applied fungicide from a seed;
(c) analysing the level of the at least one fungicide in the extracted fungicide;
(d) deducing the level of the at least one fungicide applied to the seed based on the level of the at least one fungicide present in the extracted fungicide; and
(e) correlating the level of all fungicides applied to the seed based on either the deduced level of the at least one fungicide applied to the seed or the level of the at least one fungicide present in the extracted fungicide.

10. The method of claim 9, wherein the at least one fungicide is thiabendazole.

11. A method for determining the amount of pesticides present on a seed, the method comprising:
(a) adding a desired level of thiabendazole and one or more fungicides or insecticides to the seeds during the seed treatment process;
(b) extracting the thiabendazole from a seed;
(c) analysing the level of thiabendazole in the extracted fungicide;
(d) deducing the level of thiabendazole applied to the seed based on the level of thiabendazole present in the extracted thiabendazole; and
(e) correlating the level of fungicides and/or insecticides applied to the seed based on either the deduced level of thiabendazole applied to the seed or the level of thiabendazole present in the extracted thiabendazole.

12. A kit comprising:
(a) a container;
(b) an extraction solvent;
(c) a sonicator;
(d) a fluorescence spectrometer; and
(e) a light source.
